(19) United States
(12) Patent Application Publication
(10) Pub. No.: US 2008/0212763 A1
(43) Pub. Date: Sep. 4, 2008

(54) Network-based methods and systems for responding to customer requests based on provider presence information

(76) Inventors: Girish P. Chandranmenon, Edison, NJ (US); Fang Hao, Morganville, NJ (US); Scott C. Miller, Freehold, NJ (US); Sarit Mukherjee, Morganville, NJ (US)

Correspondence Address: CAPITOL PATENT & TRADEMARK LAW FIRM, PLLC, P.O. BOX 1995, VIENNA, VA, 22183, US

(21) Appl. No.: 11/712,516

(22) Filed: Mar. 1, 2007

(51) Int. Cl. H04M 3/42

(52) U.S. Cl. 379/211.01

(57) ABSTRACT

An “always-on” network and associated systems enable customers to compare and select products and services offered by one or more providers faster than previously thought possible. In addition, communication connections may be established between customers and providers in real-time.

### BACKGROUND OF THE INVENTION

Historically, telecommunications networks have been a conduit for connecting customers to businesses that provide services. One type of service is a so-called “dispatch” service. Examples of dispatch services are a telephone repair man and a taxi cab service. The first type of service is known as a “traditional” dispatch service while the second is referred to as a “rendezvous” type of dispatch service. Typically, when a customer or potential customer (collectively referred to as “customer” herein) needs a service provided by traditional or rendezvous dispatch service the customer will use their telephone or email to contact the service provider via a network operated by a telecommunications company. For the most part, the telecommunications company is not involved in fulfilling or scheduling the service requested by the customer.

Providing products and services using the network as simply a conduit to provide a connection between a customer and provider under-utilizes the capability of such a network. For example, networks are capable of linking more than one service provider to a customer at the same time.

Another example may help further illustrate the inefficiencies that are commonplace today. If a customer wishes to call a taxi cab company and compare prices the customer must call each company individually to obtain their pricing as well as other capabilities (e.g., availability, response time).

From the provider's perspective, it would be advantageous if a provider could link its' customer service employees (e.g., technicians/installers/repairman) with a customer on a real-time basis without the need to have additional employees of the provider involved (e.g., central dispatchers). The ability to provide real-time communications between customers and employees would enable service providers to, for example, more readily diagnose the needs of a customer and determine the necessity and priority of a service visit to the customer's location.

Further, today's networks can host large databases that are created and accessed by both customers and providers to provide fast and cost efficient services.

In summary, it is desirable to make use of the capability of a telecommunications network in order to provide customers with the ability to select among a number of different providers and to provide providers with real-time connections to their customers.

### SUMMARY OF THE INVENTION

Recognizing that telecommunications networks have the ability to act as more than a mere conduit of communications between a customer and a provider, the present inventors have discovered methods and systems that allow customers to choose from a number of providers and that allow providers to communicate with their customers on a real-time basis.

More specifically, the present invention includes network-based methods and systems for monitoring the presence status of a provider irrespective of whether the provider is presently available to serve a customer or not.

In one exemplary embodiment of the present invention, the presence status of a given provider may be monitored by: maintaining a presence status in the network for one or more providers even when a given provider is not active; and forwarding information about one or more of the providers to one or more customers based on at least the presence status.

Thus, the function of monitoring the presence status of a provider is moved from the provider's backend support network to the telecommunication network. This allows provider(s) to focus their efforts and resources on fulfilling a service requested by a customer. No longer must a provider rely upon internal dispatchers, dispatch systems or the like.

Further, because the network can monitor the presence status of more than one provider and then forward the status (e.g., active or non-active) of such providers to a customer, the customer may now be able to select a service from more than one provider.

In accordance with another embodiment of the present invention, in addition to maintaining the status of providers and forwarding this information to customers, the network may also receive indications from one or more customers that they are interested in a particular product or service offered by one or more of the providers. Upon receiving such an indication, a network may forward this indication (or indications) to one or more of the providers that a given customer is interested in.

In yet a further embodiment of the present invention, a network may create a real-time communication connection between at least one customer and one provider upon receiving an indication that the customer is interested in a service or product from the provider or upon receiving an indication that a technician, repair man, or employee, etc. of a provider is interested in communicating with a customer in order to diagnose, schedule or fulfill a service or product request from a customer.

The types of providers that may make use of the methods and devices of the present invention may be traditional or rendezvous dispatch services. More specifically, the provider may be a taxi cab service, home repair or home improvement service, a utility-related service (such as telephone, computer, natural gas, home heating oil, other energy, cable television, satellite television, water, sewer, or electricity related technician).

### BRIEF DESCRIPTION OF THE DRAWINGS

FIG. 1 depicts a simplified diagram illustrating how a customer may communicate with one or more service providers using methods and systems of the present invention.

FIG. 2 depicts one example of an “always-on” (“AO”) architecture or system that may be part of the network shown in FIG. 1 or a similar network.

FIGS. 3-6 depict examples of communication flows between a customer and a provider that involve the methods and devices of the present invention.

### DETAILED DESCRIPTION OF THE INVENTION WITH EXAMPLES

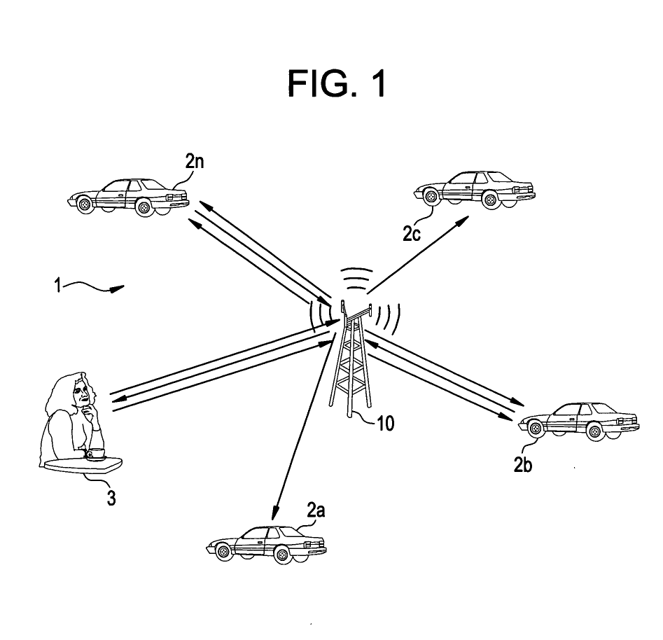

Referring to FIG. 1, there is shown a simplified diagram of an always-on network 1 which includes one or more providers 2a, 2b, 2c . . . 2n (“where n” indicates the last service provider), a customer 3 and network infrastructure/system 10. It should be understood that while only a single customer 3 is shown, the network 1 may in fact comprise a number of customers.

It should also be understood that the customer 3 includes a device, such as a portable handset, which is used to communicate with the providers 2a, 2b, 2c . . . 2n via network infrastructure 10. Further, each provider 2a-2n may represent a number of entities, such as employees of a company. Collectively, these individuals are referred to as “provider” unless something otherwise is stated or implied in the discussion that follows.

For ease of explanation the customer and handset 3 will be referred to collectively as “handset”.

It should also be understood that the handset 3 may include AO features for quickly launching applications that allow the handset 3 to communicate with the always-on network infrastructure 10 or providers 2a thru 2n. These AO features may include “1-touch” features where a user or customer may activate applications stored within the handset 3 by simply depressing a single key etc. on the handset. U.S. patent application Ser. No. 11/393,886 assigned to the same assignee as the present application describes some one touch features which allow the handset 3 to be continuously updated with a user's preferences and the like (e.g., preferred providers often requested/used by a customer). The disclosure of U.S. patent application Ser. No. 11/393,886 is incorporated by reference herein in its entirety as if it were set forth in full herein.

For example, the handset 3 may comprise one or more keys, wherein one of the keys is operable to access an application that connects the device to an always on network, such as network 1, and a transceiver for receiving information associated with one or more products or services provided by one or more providers 2a-2n or information related to customer 3, and for sending an indication to the always-on network 1 indicating the selection of one or more of the providers 2a-2n, wherein the selection is based on presence status, cost, location, or response time information (explained further below), or a request to be connected to the customer 3.

It should also be noted that each of the providers 2a-2n may also make use of a similar handset or the like. Before going further, as indicated above it should be further understood that each provider 2a-2n may include one or more individuals. These individuals may be responsible for diagnosing, scheduling, fulfilling, or otherwise responding to a request from the customer using handset 3. These individuals and their handsets are not shown in FIG. 1. The operation of handsets used by these individuals may be similar to the one used by a customer, though designed to provide responses to customer requests instead of initiating such requests.

Further, the network infrastructure 10 may use AO features that are described in U.S. patent application Ser. No. 11/393,901; U.S. patent application Ser. No. 11/393,900; and U.S. patent application Ser. No. 11/393,885. The disclosures of each of just mentioned U.S. patent applications are incorporated by reference herein in their entirety as if set forth in full herein. In these applications the AO features are described with respect to gaming applications and are, therefore, referred to as AoG features (always-on gaming).

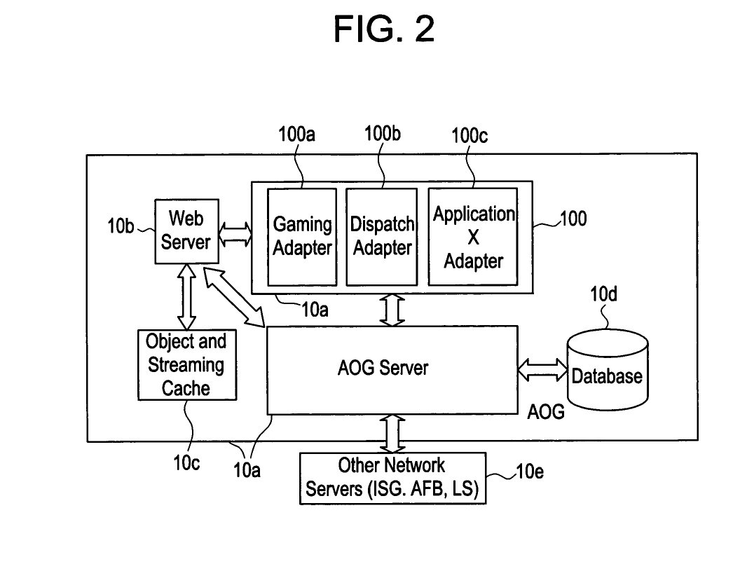

In more detail, the network infrastructure 10 may include an always on system 10a shown in FIG. 2. The always on system 10a may comprise a server or the like that is operable to communicate with each provider 2a-2n shown in FIG. 1 in order to monitor their “presence status”. For ease of explanation, the system 10a will be referred a server hereafter. Presence status is an indication of whether or not a provider is active or inactive. That is, whether or not a provider has logged onto, or has otherwise accessed, the network 1/infrastructure 10. The status of each provider (and any employees of the provider) may be tracked by system 10a. Alternatively, active may mean whether or not one or more employees of a provider 2a—(hereafter referred to as 2n have made themselves accessible to network 1/infrastructure 10a, for example, by using a handset or similar device of their own. For example, if the provider is a taxi cab company, when a driver goes “on duty” the driver may turn on his or her handset thereby becoming active and connected to the network 1. Conversely, when a driver goes “off duty” he or she may turn off their set (or it otherwise becomes inactive) thereby becoming inactive. U.S. patent application Ser. No. 11/393,901 sets forth various features that enables devices, such as always on server 10a, to monitor the presence status of devices such as those handsets used by providers 2a-2n.

In accordance with the present invention, the status of each of the providers 2a-2n (as well as the customer 3) may be monitored even when a provider or customer is inactive.

Each provider, employee of a provider, or customer may be associated with preferences which may be stored within the always-on server 10a. These preferences may be continuously monitored by the server 10a even when the provider, employee, or customer is no longer active. When the provider, employee, or customer become active again the always on server 10a may forward messages to the now active component of network 1 to enable the component to receive information collected by the always-on server 10a during the time period when the component was inactive.

Referring again to FIG. 2, it can be seen that the always-on server or system 10a may communicate with one or more devices or platforms 100. Though shown as separate components, it should be understood that platform 100 and server/system 10a may be a part of a single component. Further, though shown as two components it should be understood that the server 10a and component 100 may comprise more than two components. As shown in FIG. 2, platform 100 may include one or more subcomponents or subplatforms 100a-100c. Such sub-platforms may consist of a gaming adapter 100a, dispatch adapter 100b, or application “x” adapter 100c. By “x” is meant that this adapter may be operable to complete any number of applications which require the presence status of a subscriber, customer or provider to be monitored in order to provide real-time services and or communications. The gaming adapter 100a is more fully described in the U.S. patent applications mentioned above.

In accordance with yet another embodiment of the present invention, the dispatch adapter 100b may be operable to maintain the presence status of one or more of the providers 2a-2n even when one of the providers is not active. Further, the adapter 100b may be operable to forward information about one or more of the providers to one or more customers, such as customer 3, based on at least the presence status of a provider 2a-2n. Further, upon receiving an indication from a customer, such as customer 3, that the customer is interested in a product or service offered by a provider 2a-2n the dispatch adapter 100b may forward the indication (or another indication) on to the provider 2a-2n of interest.

In accordance with embodiments of the present invention, the dispatch adapter 100b may be the component that executes (and/or controls the execution on the features and functions necessary to provide the customer 3 with information from providers 2a-2n and which enables a technician employed by a provider 2a-2n, for example, to communicate on a real-time basis with the customer 3. The dispatch adapter 100b, as well as other components of platform 100 may comprise hardware, software, or firmware. Such software or firmware may be stored on one or more computer readable mediums (e.g., hard drives, disk drives, memory, etc.,) that may be a part of the adapter 100b or server 10a, for example.

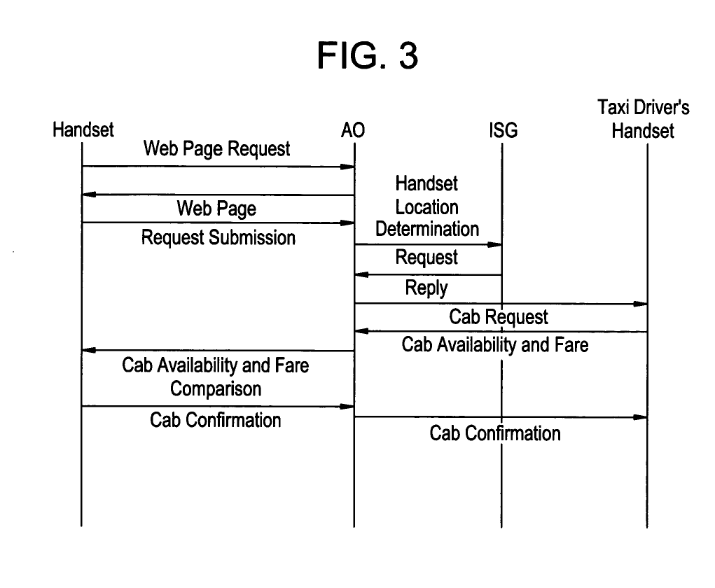

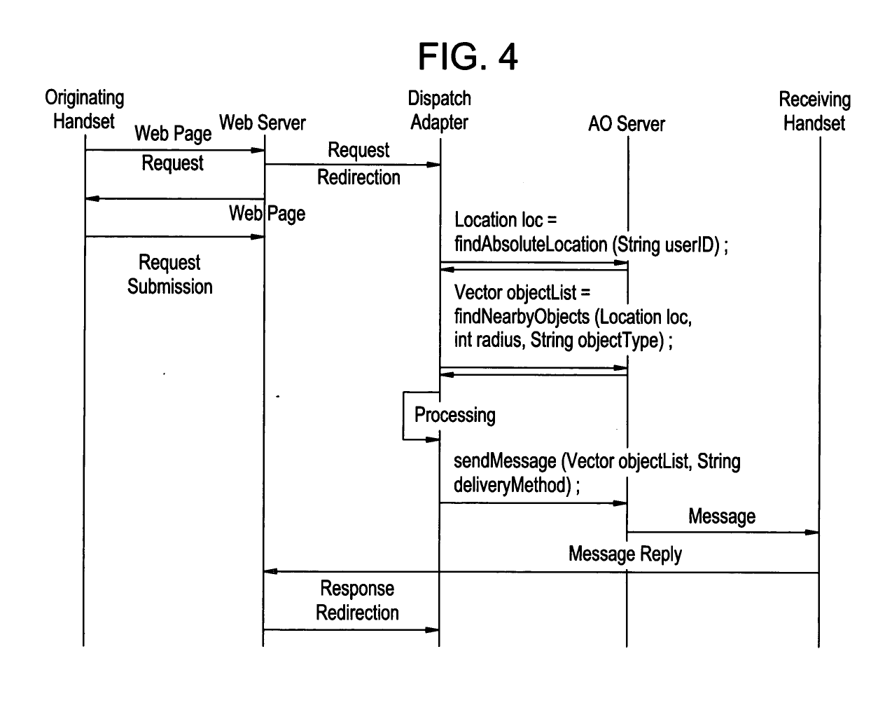

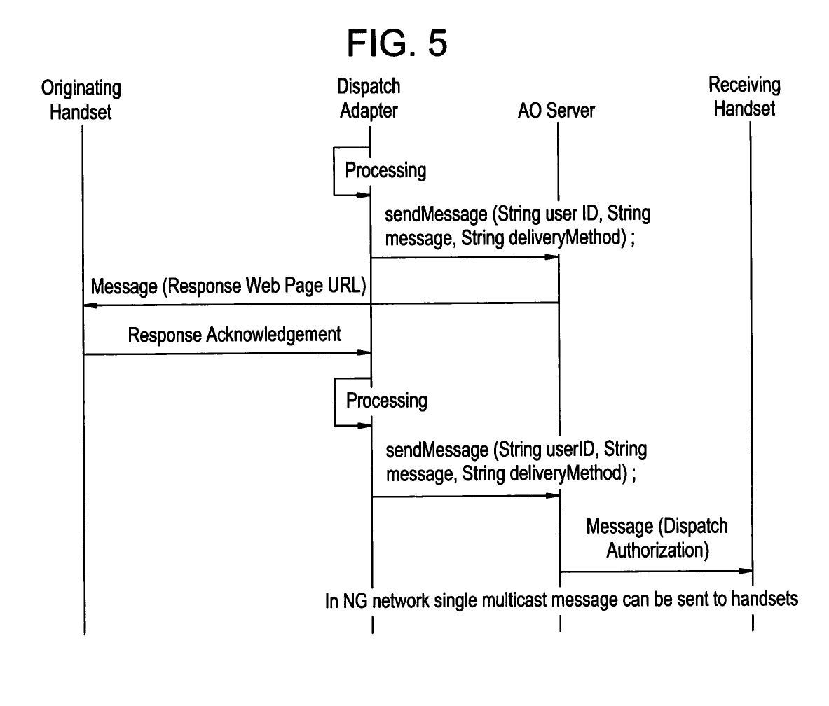

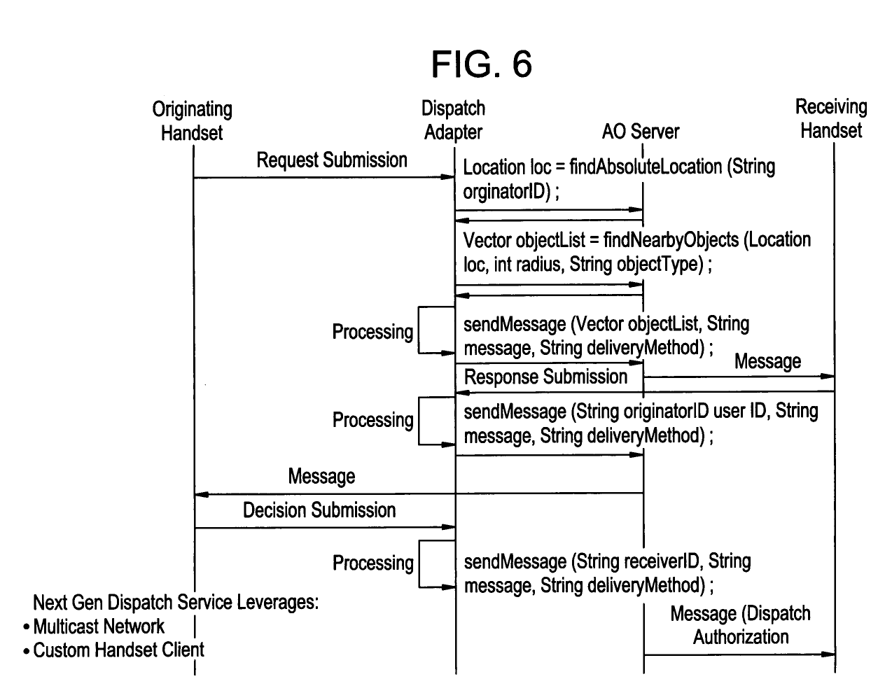

FIGS. 3 thru 6 provide some examples of communication flows between the handset 3 and a service provider 2a-2n. In particular, FIG. 3 depicts an exemplary call flow which may be used in the handset 3 that includes a “1-touch” feature which allows a customer to access information concerning a plurality of providers 2a-2n by simply depressing one key, for example, on handset 3. Such a feature may be referred to as a “push-to-taxi” when the provider is a taxi cab company. FIGS. 4-6 depict call flows that may be used with so called “Next Generation” handsets (e.g., 3G handsets and the like). Though FIGS. 3-6 depict the use of a telephone, it should be understood that an email or data communications device may also be used as well.

Though the discussion above has used a traditional or rendezvous dispatch service as examples of providers 2a-2n, it should be understood that the providers 2a-2n may comprise other types of providers. For example, providers 2a-2n may be providers that sell products, or ones that sell services, such as home repair or home improvement services. Further, one or more of the providers 2a-2n may be a utility-related service, telephone company, computer repair company, natural gas company, home heating oil company, other energy related company, cable television company, satellite television company, water service company, sewer company, electricity company. In addition, the methods and devices provided by the presence invention may often include providers 2a-2n that are emergency services personnel such as police, fire department, EMT, and ambulance service providers.

In addition to forwarding presence status information to a customer, the server 10a in conjunction with the platform 100 may be operable to forward other information that may be useful to the customer 3. For example, the server 10a/platform 100 may forward information about: the cost of products/services provided by the provider, response time or scheduling information, and or location information, to name just a few examples.

Providers 2a-2n may be distinct (i.e., unaffiliated, independent) providers, such as an independent taxi cab driver, or they may be affiliated with one another. For example, they may be franchisees that belong to the same franchise. Said another way, the service providers 2a-2n may, or may not be, a part of the same business entity.

Referring back to FIG. 2, the always-on architecture 10a may also include one or more databases 10d for storing information, such as presence status information, associated with the providers' 2a-2n and customer 3.

When communications with a customer are via the Internet or another data communications network, one or more web servers 10b may be included in architecture 10a to enable the exchange of messages between customers and the architecture 10a and to otherwise assist in setting up a connection between a customer and a provider. Further, one or more of the web servers 10b may be a specialized web server that enables a customer to access games or other specialized applications that may be downloaded on to a handset, such as handset 3.

In general, features and functions residing within adapters 100a-100d may be accessed by a customer 3 via a web server 10b or the like.

To summarize, because the always on server 10a may constantly monitor the presence status of a provider 2a-2n it can very quickly provide a customer 3 with a response to a request initiated by a customer. For example, instead of having a customer wait for a response from a cab company related to whether or not a driver is available to drive the customer to a desired destination by a desired time period this information may be instantaneously available to a customer once the customer accesses architecture 10a/platform 100. The amount of time it takes for a customer to identify and select a provider may be substantially reduced. Further, once a customer 3 has selected a provider 2a-2n the server 10a and platform 100 enable an employee of a provider 2a-2n, responsible for satisfying the customer's request, to become linked or otherwise connected to the customer 3 in a substantially shorter time frame than previously thought possible using conventional dispatchers or dispatch systems.

Though the description above has set forth some examples in order to illustrate the methods and devises of the present invention, the scope of the present invention is given by the claims that follow.

We claim:

1. A network-based method for monitoring the presence of a provider comprising:
maintaining a presence status in the network for each of one or more providers even when a provider is not active; and
forwarding information about one or more of the providers from the network to at least one customer based on at least the presence status.

2. A method as in claim 1 further comprising:
receiving an indication from the customer that the customer is interested in a product or service offered by at least one of the providers; and
forwarding the indication to the provider.

3. The method as in claim 1 wherein one or more of the providers offer a dispatch service.

4. The method as in claim 3 wherein the dispatch service is a taxi cab service.

5. The method as in claim 1 wherein one or more of the providers offer a service selected from the group consisting of: home repair or improvement service, a telephone service, a computer related service, a natural gas service, a home heating oil service, a cable television service, a satellite television service, a water service, a sewer related service, an electricity related service, or an energy related service.

6. The method as in claim 1 wherein one or more of the providers offer an emergency service selected from the group consisting of: police, fire department, EMT, or ambulance related service.

7. The method as in claim 1 further comprising forwarding cost information associated with one or more of the providers, whose presence status indicates they are active, to the customer.

8. A method as in claim 1 further comprising forwarding time information associated with the service offered by one or more providers, whose presence status indicates they are active, to the customer.

9. The method as in claim 1 further comprising forwarding location information from one or more providers, whose presence status indicates they are active, to the customer.

10. The method as in claim 1 when one or more of the providers are not affiliated with one another.

11. The method as in claim 1 further comprising:
creating a real-time communications connection between the customer and one of the providers.

12. A network-based system for monitoring the presence of a provider, the system operable to:
maintain a presence status in the network for each of one or more providers even when a provider is not active; and
forward information about one or more of the providers from the network to at least one customer based on at least the presence status.

13. The system as in claim 12 further operable to:
receive an indication from the customer that the customer is interested in a product or service offered by at least one of the providers; and
forward the indication to the provider.

14. The system as in claim 12 wherein one or more of the providers offer a dispatch service.

15. The system as in claim 14 wherein the dispatch service is a taxi cab service.

16. The system as in claim 12 wherein one or more of the providers offer a service selected from the group consisting of: home repair or improvement service, a telephone service, a computer related service, a natural gas service, a home heating oil service, a cable television service, a satellite television service, a water service, a sewer related service, an electricity related service, or an energy related service.

17. The system as in claim 12 wherein one or more of the providers offer an emergency service selected from the group consisting of: police, fire department, EMT, or ambulance related service.

18. The system as in claim 12 further operable to forward cost information associated with one or more of the providers, whose presence status indicates they are active, to the customer.

19. The system as in claim 12 further operable to forward time information associated with the service offered by one or more providers, whose presence status indicates they are active, to the customer.

20. The system as in claim 12 further operable to forward location information from one or more providers, whose presence status indicates they are active, to the customer.

21. The system as in claim 12 wherein one or more of the providers are not affiliated with one another.

22. The system as in claim 12 further operable to:
create a real-time communications connection between the customer and one of the providers.

23. A device for accessing an always-on network comprising:
one or more keys, wherein one of the keys is operable to access an application that connects the device to an always on network; and
a transceiver for receiving information associated with one or more products or services provided by one or more providers or information related to a customer, and for sending an indication to the always-on network indicating the selection of one or more of the providers, wherein the selection is based on presence status, cost, location, or response time information, or a request to be connected to the customer.
